(19) United States
(12) Patent Application Publication
(10) Pub. No.: US 2024/0331099 A1
(43) Pub. Date: Oct. 3, 2024

(54) BACKGROUND REPLACEMENT WITH DEPTH INFORMATION GENERATED BY STEREO IMAGING

(71) Applicant: Visionary .Al Vision Ltd., Jerusalem (IL)

(72) Inventors: David Huberman, Jerusalem (IL); Nadav Cohen, Tel Aviv-Yafo (IL); Yoav Taeib, Jerusalem (IL)

(21) Appl. No.: 18/625,545

(22) Filed: Apr. 3, 2024

Related U.S. Application Data
(60) Provisional application No. 63/493,794, filed on Apr. 3, 2023.

(51) Int. Cl. G06T 5/50; G06T 7/194; G06T 7/593

(52) U.S. Cl. CPC G06T 5/50; G06T 7/194; G06T 7/593; G06T 2207/20084; G06T 2207/20221

(57) ABSTRACT

A method of background replacement includes: receiving a main image of a scene from a main image sensor and a secondary image of a scene from a secondary image sensor, wherein the main image sensor and secondary image sensor are displaced relative to each other in at least one dimension; performing stereo rectification on the main image and secondary image; inputting the rectified images into a deep neural network, and applying the deep neural network on the rectified images to generate an alpha matting mask for the main image.

### FIELD OF THE INVENTION

The present Application relates to the field of digital image processing, and more specifically, but not exclusively, to an improved method for background replacement using stereo imaging to generate depth information.

### BACKGROUND OF THE INVENTION

Image segmentation is an essential component of computer vision systems. Image segmentation involves partitioning images, or video frames, into multiple segments or objects.

One common practical use of image segmentation is background replacement. Background replacement is accomplished by generating an alpha matting mask (i.e., delineating boundaries of the foreground) and foreground color scheme from an image. Following generation of the alpha matting mask, the foreground is extracted from the original image and composited onto a new background. Background replacement has many practical applications, including video conferencing and entertainment video creation, in which human subjects utilize real-time background replacement without green-screen props.

Most current strategies for image segmentation, and in particular generation of an alpha matting mask, use deep learning networks, such as convolutional neural networks or recurrent neural networks. Various architectures have been developed for deep learning networks that perform image segmentation.

Stereo imaging systems have been implemented for background blurring. In one example, a depth map is generated from dual cameras, and the information from the depth map is used in order to select certain background portions of the image for blurring. The blurring induces a simulated Bokeh effect, which is the aesthetic quality of the blur produced in out-of-focus parts of an image.

### SUMMARY OF THE INVENTION

Known methods of image segmentation, including those based on deep learning, use two-dimensional images as inputs. Because a two-dimensional image lacks any intrinsic indicia of depth, the deep neural network processing the image cannot incorporate depth into its determination of the alpha matting mask. As a result, the alpha matting determination is sometimes erroneous. For example, when the person is standing in front of a column or pole, the algorithm may determine that a portion of the person's arm is similar in appearance to the pole, and hence erroneously assign the arm to the background. Similarly, when the person is wearing or holding accessories, such as jewelry, glasses, a cell phone, or a pen, the deep learning algorithm may erroneously exclude the accessories from the alpha matte.

In addition, background blurring is a different technical task than alpha matting. Background blurring is relatively forgiving of errors and uncertainty, because blur gradients look natural. By contrast, alpha matting generally requires a crisp and well-defined edge. Background blurring is generally considered less technically complex than alpha matting. Thus, work on background blurring may not be easily applied, without undue experimentation, to address challenges related to alpha matting.

The present disclosure discloses a system and method for incorporating depth perception into image segmentation and alpha matte determination. This depth perception is achieved by capturing an image of a subject from two or more image sensors simultaneously. The two images are rectified, which enables determination of depth for the imaged items. The images are then fed into the deep neural network. The deep neural network incorporates all relevant data, including depth information, in order to determine the contours of the alpha matting mask. Due to the inclusion of depth information, the alpha matting is more accurate, and properly divides the image into foreground and background.

According to a first aspect, a method of background replacement is disclosed. The method includes: receiving a main image of a scene from a main image sensor and a secondary image of a scene from a secondary image sensor, wherein the main image sensor and secondary image sensor are displaced relative to each other in at least one dimension; performing stereo rectification on the main image and secondary image; inputting the rectified images into a deep neural network, and applying the deep neural network on the rectified images to generate an alpha matting mask for the main image.

In another implementation according to the first aspect, the step of applying a deep neural network comprises performing a depth determination on the pixels of the main image based on displacement of the pixels of the secondary image relative to the main image.

Optionally, the method further includes, within the deep neural network: applying a segmentation algorithm on input received from the main image sensor prior to application of the depth determination; applying a stereo alpha matting algorithm incorporating depth information on input received from the main image sensor; and weighting the respective outputs of the segmentation algorithm and the stereo alpha matting algorithm in order to obtain an optimized output for the alpha matting mask.

In another implementation according to the first aspect, the alpha matting mask defines a silhouette of a person and objects placed upon or held by the person.

In another implementation according to the first aspect, the method further includes generating a combined image by applying a new background to the alpha matting mask.

Optionally, the step of generating a combined image comprises selecting a value for each pixel [i,j] of the combined image based on the following formula:

$$combined Image [ i , j ] = image [ i , j ] * alpha [ i , j ] + bg [ i , j ] * ( 1 - alpha [ i , j ] )$$

wherein image[i,j] represents the value of the pixel from the rectified image; bg[i,j] represents the value of the pixel from the background; and alpha[i,j] represents a value of 1 when the pixel is included in the alpha matte and zero when the pixel is not included in the alpha matte.

In another implementation according to the first aspect, the method further includes capturing the plurality of images with the image sensors.

Optionally, the image sensors are integrated within a single hardware device.

According to a second aspect, a system is disclosed. The system includes a main image sensor and a secondary image sensor, the secondary image sensor being displaced in at least one dimension relative to the main image sensor; and a computer program product comprising instructions, which, when executed by a computer, cause the computer to carry out the following steps: receiving a main image of a scene from the main image sensor and a secondary image of the scene from the secondary image sensor; performing stereo rectification on the images; inputting the rectified images into a deep neural network, and applying the deep neural network on the rectified images to generate an alpha matting mask for the main image.

In another implementation according to the second aspect, the instructions further include, during application of the deep neural network, performing a depth determination on the pixels of the main image based on displacement of the pixels of the secondary image relative to the main image.

Optionally, the instructions further include, within the deep neural network, applying a segmentation algorithm on input received from the main image sensor prior to application of the depth determination; applying a stereo alpha matting algorithm incorporating depth information on input received from the main image sensor following application of the depth determination; and weighting the respective outputs of the first alpha matting algorithm and the second alpha matting algorithm in order to obtain an optimized output for the alpha matting mask.

In another implementation according to the second aspect, the alpha matting mask defines a silhouette of a person and objects placed upon or held by the person.

In another implementation according to the second aspect, the computer program product is configured to generate the combined image by applying a new background to the alpha matting mask.

Optionally, the computer program product is configured to select a value for each pixel [i,j] of the combined image based on the following formula:

$$combined Image [ i , j ] = image [ i , j ] * alpha [ i , j ] + bg [ i , j ] * ( 1 - alpha [ i , j ] )$$

wherein image[i,j] represents the value of the pixel from the rectified image; bg[i,j] represents the value of the pixel from the background; and alpha[i,j] represents a value of 1 when the pixel is included in the alpha matte and zero when the pixel is not included in the alpha matte.

In another implementation according to the second aspect, the image sensors are integrated within a single hardware device.

### BRIEF DESCRIPTION OF THE DRAWINGS

FIG. 1 illustrates steps in a method for background replacement, according to embodiments of the present disclosure;

FIG. 2A illustrates a pipeline from image capture to generation of an alpha matting mask, according to embodiments of the present disclosure;

FIG. 2B illustrates different algorithms utilized by the Deep Neural Network, according to embodiments of the present disclosure;

FIG. 3 illustrates application of a background replacement onto the alpha matting mask, according to embodiments of the present disclosure;

FIG. 4 illustrates an exemplary apparatus incorporating two image sensors that simultaneously image a person, according to embodiments of the present disclosure;

FIG. 5 illustrates principles of stereo rectification, according to embodiments of the present disclosure; and

FIGS. 6A-6I illustrate comparisons of alpha matting performed according to standard techniques versus alpha matting performed using stereo imaging, according to embodiments of the present disclosure.

### DETAILED DESCRIPTION OF THE INVENTION

The present Application relates to the field of digital image processing, and more specifically, but not exclusively, to an improved method for background replacement using stereo imaging.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

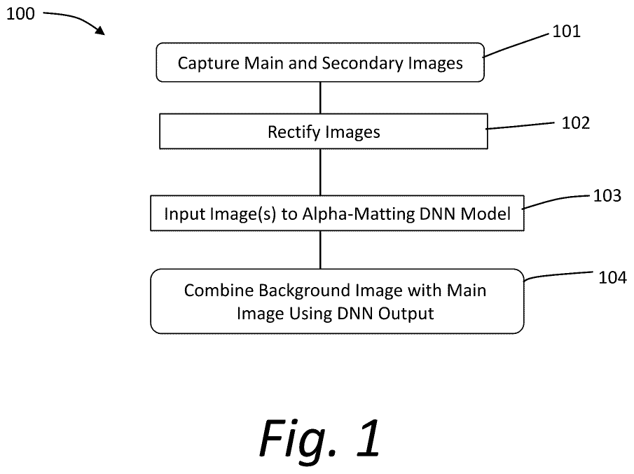

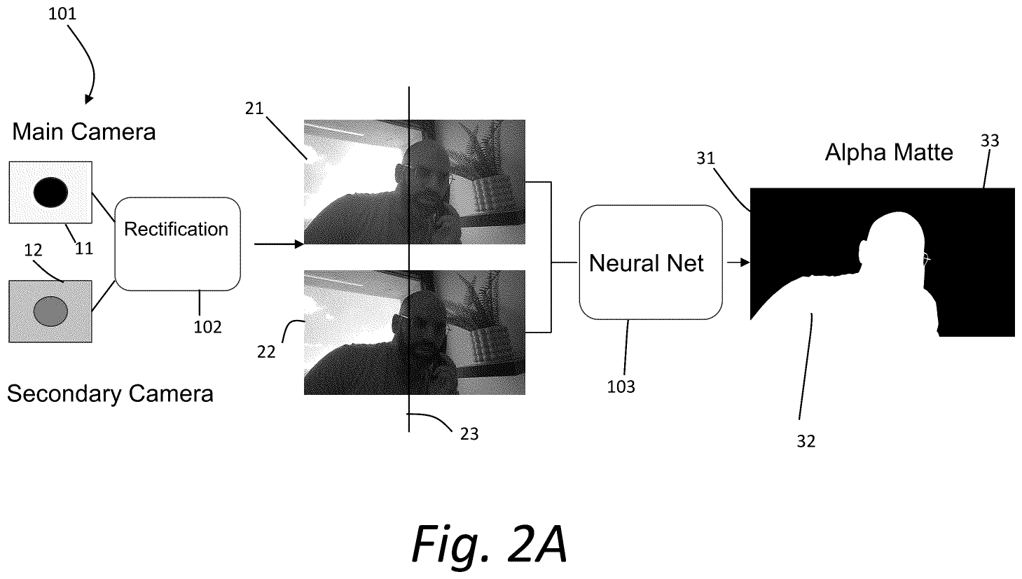

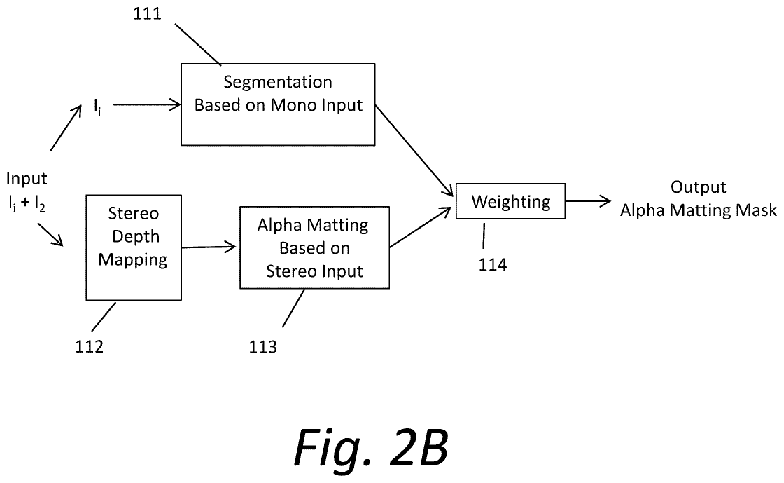

FIG. 1 depicts steps in a method of background replacement. Different aspects of this method are illustrated in FIGS. 2-5.

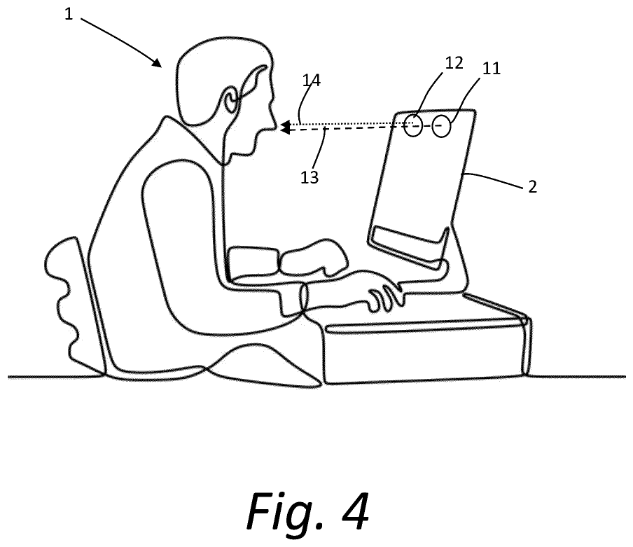

Referring to FIG. 1, at step 101, a system captures main and secondary images. The system may be a computing device 2 including two image sensors. For example, in FIG. 4, computing device 2 includes two built-in image sensors-main image sensor 11 and secondary image sensor 12. Vector 13 extends from image sensor 11 to the tip of a nose of a person 1, and vector 14 extends from image sensor 12 to the tip of the nose. Although, in the illustrated embodiment, the computing device 2 is a desktop computer, the computing device 2 may also be a handheld computing device, a laptop computer. The image sensors may also be standalone devices, e.g., two cameras set on tripods, and connected to the computing device with a wired or wireless connection. The image sensors may be any suitable sensor for detecting and capturing an image, for example, a CMOS sensor or a CCD sensor.

In the illustrated embodiment, there are two image sensors 11, 12. While two is the minimum number of cameras required for depth measurement, depth measurement may also be performed through triangulation of data points taken from more than two cameras, as will be recognized by those of skill in the art.

The computing device 2 includes a processor and a memory. The memory is a non-transitory computer-readable medium containing computer-readable instructions, that, when executed by the processor, causes the computer to perform the steps described in the present disclosure. In particular, the memory includes a computer program product configured to, based on the input of two or more images, rectify the images, perform image segmentation, determine an alpha matte, and perform background replacement, as described herein. The computer program product may be stored on a physical memory of the computing device 2 or may be stored in a cloud-based or network-based memory.

As stated above, image sensor 11 is designated the “main” image sensor and image sensor 12 is designated the “secondary” image sensor. These designations refer not to the hardware capabilities of the image sensors, which may be identical, but to the uses of the images generated from each image sensor. The “main” image sensor generates the images that are used for standard videoconferencing or video recording. It is onto these images that the alpha matting mask is applied. The images generated from the second image sensor 12 are used primarily for rectification and determination of depth. Once depth is determined, this information is assigned to the pixels of the image obtained from the first image sensor 11. Accordingly, main image sensor 11 is typically centrally located on or within the computer 2, such that the person engaging in the videoconference is positioned directly across from the main image sensor 12. The secondary image sensor 12 is displaced peripherally relative to the main image sensor 11. Optionally, main image sensor 11 may be of higher resolution than the secondary image sensor 12.

Returning to FIG. 1, at step 102, the system rectifies the images that are captured by the main image sensor 11 and the secondary image sensor 12. FIG. 2 illustrates two images 21, 22 of the same scene that are captured by a main image sensor 11 and a secondary image sensor 12. Image 21 is designated as the “main image,” and image 22 is designated as the “secondary image.” Although the images appear to be horizontally aligned, image 22 is horizontally displaced by a few pixels relative to image 21. For example, line 23 crosses image 21 in the middle of the temple of the subject's glasses, while the line 23 crosses image 22 at the junction of the temple and the rim.

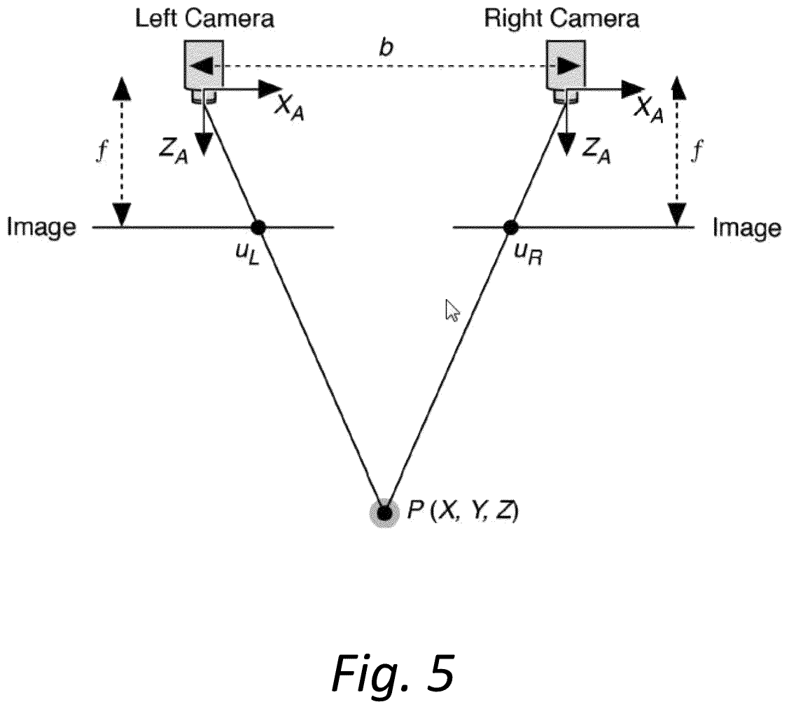

The horizontal displacement of the two images may be used to determine depth. FIG. 5 generally illustrates the process by which images from multiple cameras are compared in order to determine depth. A left camera and a right camera are located at a fixed distance b from each other in the X-dimension. Each camera captures an image at the same focal length f from the image sensor, in the Z dimension. The vector from the left camera to target P crosses the plane defined by the focal length at u_{L}. The vector from the right camera to target P crosses the plane defined by the focal length at u_{R}. u_{L} and u_{R} are displaced from each other along the X-axis. The magnitude of this displacement depends on the distance of P, in the Z-axis, from each of the cameras. When the distance is smaller (i.e., when the object is closer to the cameras), the displacement is greater, and when the distance is greater (when the object is further from the cameras), the displacement is less. Based on this principle, objects that are imaged may be assigned a distance from the cameras.

The comparison described in connection with FIG. 5 is relatively straightforward, because the two cameras are displaced only on a single axis. When the cameras are also displaced on a second or even a third axis, it is necessary to rectify the images. Rectification refers to transforming the images by projecting the images onto a single virtual image plane. Rectification simplifies the process of finding correspondence between equivalent points. As used in the present disclosure, the term “stereo rectification” refers to the combination of the processes of rectification and determination of displacement.

At step 103, the two rectified images, are fed into an alpha-matting deep neural network, for determination of the alpha matting mask. The pixels of each of the images are embedded into the deep neural network using any suitable method.

As shown in FIG. 2B, the deep neural network is equipped with multiple layers that apply a plurality of algorithms and weightings. Accordingly, the rectified images are fed into the deep neural network prior to the determination of depth. The DNN performs an end-to-end analysis, starting with the two rectified images, and ending with the alpha matting mask. As part of this process, the DNN may consider the depth of each pixel, which may be calculated by the methods described above. However, this is not strictly necessary, and there is no intermediate output of a depth map at any point.

In one advantageous embodiment, at layer 111, the DNN applies a segmentation algorithm on the input of a single image (I₁). Image I₁ is input received from the main image sensor, prior to application of the depth determination. The segmentation algorithm may be a conventional 2D segmentation algorithm for mono input, such as one based on semantic segmentation or patch-based refinement. At layer 112, the DNN applies a disparity calculation onto both images I₁ and I₂, received from the main image sensor and the secondary image sensor, as discussed above. At layer 113, the DNN applies a stereo alpha matting algorithm onto the images with the depth information. Layers 112 and 113 may utilize any deep neural network or matching algorithm suitable for processing images while including stereo inputs and depth information. For example, a stereo matching algorithm may use a convolutional neural network to perform a matching costs calculation or to generate a stereo-based disparity map. At layer 114, the deep neural network performs a weighting process on the outputs of the segmentation algorithm and the alpha matting algorithm. The deep neural network may determine, on a pixel-by-pixel basis, whether an optimum output for the alpha matting mask is achieved with the mono segmentation or the stereo segmentation.

One advantage of utilizing an input into the DNN that is capable of depth determination, but that does not explicitly include depth information in the inputted images, is that, the DNN is able to select, on a pixel-by-pixel basis, how to apply the alpha matting algorithm. For certain pixels, the DNN may determine that a conventional 2D segmentation algorithm provides the best results. For other pixels, the DNN may utilize a stereo matching algorithm, as discussed. Implementing the depth determination and the alpha matting as an integrated, end-to-end process gives the network the strength to determine which algorithm to use and when to use it.

Returning to FIG. 2A, the DNN outputs an alpha matting mask for the main image. As seen in FIG. 2A, alpha matting mask 31 divides the main image into a foreground section 32 and a background section 33. The foreground section 32 represents a silhouette of a person and objects placed upon or held by the person.

Advantageously, because the alpha matting is performed while taking depth information into account, the resulting alpha matting mask is more accurate than equivalent processes that on two-dimensional images without depth information. For example, in the images 21, 22 that are illustrated in FIG. 2, the subject is both wearing glasses and holding a mobile phone. Both the glasses and the phone are properly assigned to the foreground section 32. By contrast, elements such as the plant, shelf, and window are properly assigned to the background section 33. Other deep neural networks lacking depth information may erroneously assign some of these elements to the wrong section.

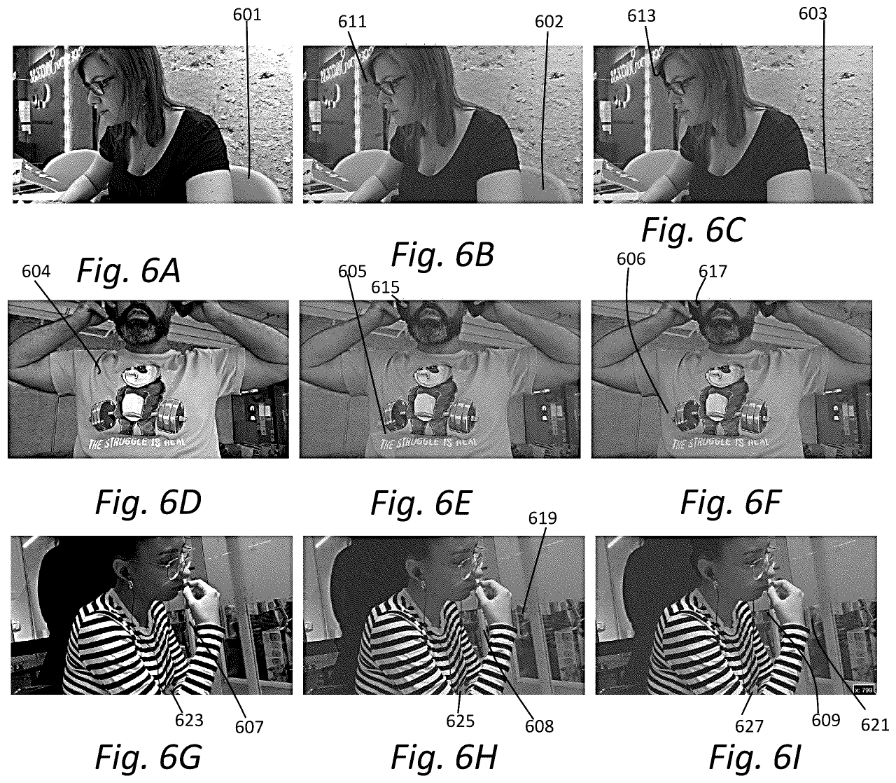

FIGS. 6A-6I illustrate various examples of alpha matting performed both with conventional, mono video capture as well as with stereo capture. In FIG. 6A, the woman that is pictured is sitting in a chair 601 that is very similar in color to the wall behind it. In FIG. 6B, alpha matting is performed using a single camera view. The matting is unable to distinguish between the edge of the chair and the wall, and thus a portion of the chair back 602 is assigned to the background. In addition, the division between the woman's hair 612 and the wall is blurred. FIG. 6C illustrates the alpha matting performed based on stereo photography. The chair back 603 is properly assigned, in its entirety, to the foreground, and the division 613 between the hair and the wall is performed accurately.

FIG. 6D illustrates a second example. The pictured man is wearing a shirt 604 that is similar in color to the wall behind him, and the man is wearing headphones. In FIG. 6E, an alpha matting was performed based on a single camera. The alpha matting erroneously assigned a portion 605 of the shirt to the background. In addition, the alpha matting erroneously assigned a portion of the headphones 615 to the background. FIG. 6F shows the results of alpha matting using stereo input. The shirt 606 is completely assigned to the foreground, as are the headphones 617.

FIG. 6G illustrates a third example. The pictured woman is sitting in front of a window frame 607 whose coloring is similar to that of her shirt. The woman has her arms crossed in front of her with a small gap between her left forearm and her chest, and a larger gap between her right forearm and her chest. In FIG. 6H, the alpha matting was performed using a single image. The gap 609 between the woman's right forearm and chest is erroneously assigned to the foreground, as is the gap 625 between the left forearm and the chest. In addition, another portion of the window 619 outside of the woman's left forearm is improperly assigned to the foreground. FIG. 6I shows the results of alpha matting using stereo input. Window portion 609, window portion 621, and gap 627 are properly assigned to the background.

In order to quantify the improvement that is reached through use of stereo imaging, alpha matting was performed on 300 images captured simultaneously with mono and stereo imaging. The results for alpha matting obtained through the deep neural network were then compared to ground truth. Overall, the mono network had errors on 1.17% of the pixels, versus 0.82% for the stereo network. When looking separately at the foreground and background accuracy, the two methods had similar error rates of 0.96% for pixels that were classified according to ground truth as foreground. However, the stereo imaging network had only 0.86% error rate for pixels that were classified according to ground truth as background, as opposed to a 1.46% error rate for the mono imaging network.

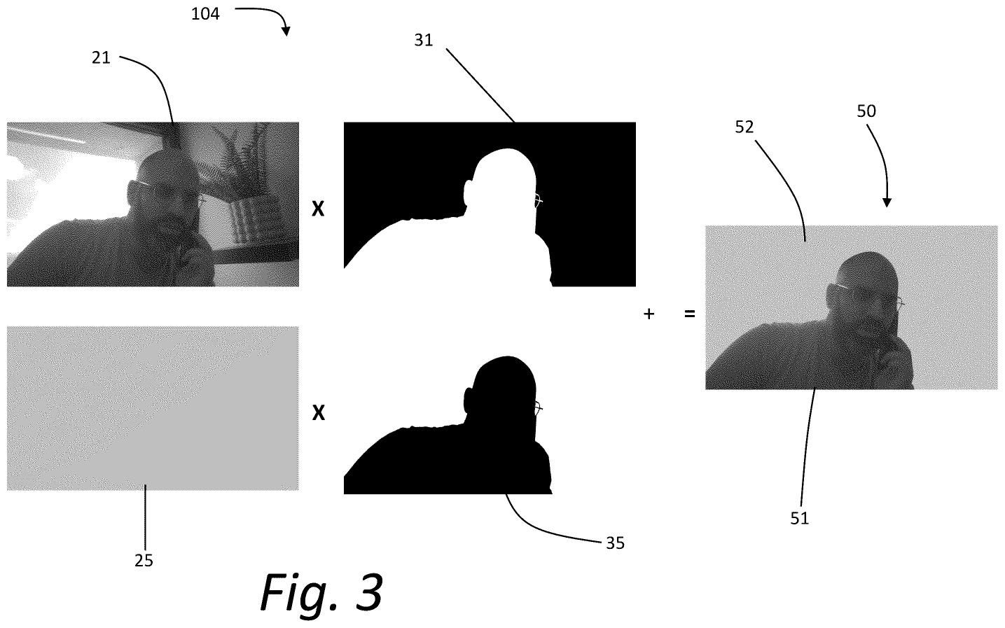

At step 104, the system combines a background image with the main image using the alpha matte that was output by the deep neural network. This process is illustrated pictorially in FIG. 3. Image 21 is combined with background 25 by applying the alpha matte 31 onto the image 21. Simultaneously, the inverse 35 of the alpha matte 31 is applied to the background 25. The resulting display 50 thus includes pixels 51 taken from the alpha matte of the main image and pixels 52 taken from the background 25. The makeup of the display 50 may be described mathematically for each pixel [i,j] based on the following formula:

$$combined image [ i , j ] = image [ i , j ] * alpha [ i , j ] + bg [ i , j ] * ( 1 - alpha [ i , j ] )$$

wherein image[i,j] represents the value (e.g., the RGB value) of the pixel from the rectified main image; bg[i,j] represents the (RGB) value of the pixel from the background; and alpha[i,j] represents a value between 0 and 1. alpha[i,j] has a value of 1 when the pixel is entirely included in the alpha matting mask and zero when the pixel is not included in the alpha matting mask, and has a value of between 0 and 1 around the edges of the alpha matting mask.

What is claimed is:

1. A method of background replacement, comprising:
receiving a main image of a scene from a main image sensor and a secondary image of a scene from a secondary image sensor, wherein the main image sensor and secondary image sensor are displaced relative to each other in at least one dimension;
performing stereo rectification on the main image and secondary image;
inputting the rectified images into a deep neural network; and
applying a deep neural network on the rectified images to generate an alpha matting mask for the main image.

2. The method of claim 1, wherein the step of applying a deep neural network comprises performing a depth determination on the pixels of the main image based on displacement of the pixels of the secondary image relative to the main image.

3. The method of claim 2, further comprising, within the deep neural network:
applying a segmentation algorithm on input received from the main image sensor prior to application of the depth determination;
applying a stereo alpha matting algorithm incorporating depth information on input received from the main image sensor; and
weighting the respective outputs of the segmentation algorithm and the stereo alpha matting algorithm in order to obtain an optimized output for the alpha matting mask.

4. The method of claim 1, wherein the alpha matting mask defines a silhouette of a person and objects placed upon or held by the person.

5. The method of claim 1, further comprising generating a combined image by applying a new background to the alpha matting mask.

6. The method of claim 5, wherein the step of generating a combined image comprises selecting a value for each pixel [i,j] of the combined image based on the following formula:
$$combined Image [ i , j ] = image [ i , j ] * alpha [ i , j ] + bg [ i , j ] * ( 1 - alpha [ i , j ] )$$
wherein image[i,j] represents the value of the pixel from the rectified image; bg[i,j] represents the value of the pixel from the background; and alpha[i,j] represents a value of 1 when the pixel is included in the alpha matting mask and zero when the pixel is not included in the alpha matting mask.

7. The method of claim 1, further comprising capturing the plurality of images with the image sensors.

8. The method of claim 7, wherein the image sensors are integrated within a single hardware device.

9. A system comprising:
a main image sensor and a secondary image sensor, the secondary image sensor being displaced in at least one dimension relative to the main image sensor; and
a computer program product comprising instructions, which, when executed by a computer, cause the computer to carry out the following steps:
receiving a main image of a scene from the main image sensor and a secondary image of the scene from the secondary image sensor;
performing stereo rectification on the images;
inputting the rectified images into a deep neural network; and
applying a deep neural network on the rectified images to generate an alpha matting mask for the main image.

10. The system of claim 9, wherein the instructions further include, within the deep neural network, performing a depth determination on the pixels of the main image based on displacement of the pixels of the secondary image relative to the main image.

11. The system of claim 10, wherein the instructions further include, within the deep neural network, applying a segmentation algorithm on input received from the main image sensor prior to application of the depth determination; applying a stereo alpha matting algorithm incorporating depth information on input received from the main image sensor following application of the depth determination; and weighting the respective outputs of the first alpha matting algorithm and the second alpha matting algorithm in order to obtain an optimized output for the alpha matting mask.

12. The system of claim 9, wherein the alpha matting mask defines a silhouette of a person and objects placed upon or held by the person.

13. The system of claim 9, wherein the computer program product is configured to generate the combined image by applying a new background to the alpha matting mask.

14. The system of claim 9, wherein the computer program product is configured to select a value for each pixel [i,j] of the combined image based on the following formula:
$$combined Image [ i , j ] = image [ i , j ] * alpha [ i , j ] + bg [ i , j ] * ( 1 - alpha [ i , j ] )$$
wherein image[i,j] represents the value of the pixel from the rectified image; bg[i,j] represents the value of the pixel from the background; and alpha[i,j] represents a value of 1 when the pixel is included in the alpha matte and zero when the pixel is not included in the alpha matting mask.

15. The system of claim 9, wherein the image sensors are integrated within a single hardware device.
